(19) United States
(12) Patent Application Publication
(10) Pub. No.: US 2025/0217463 A1
(43) Pub. Date: Jul. 3, 2025

(54) Biometric Identity Lock Instrument (BILI)

(71) Applicant: Jose Manuel Santiago, Sarasota, FL (US)

(72) Inventor: Jose Manuel Santiago, Sarasota, FL (US)

(21) Appl. No.: 19/002,707

(22) Filed: Dec. 27, 2024

(51) Int. Cl. G06F 21/32; H04L 9/00; H04L 9/32

(52) U.S. Cl. CPC G06F 21/32; H04L 9/321; H04L 9/50

(57) ABSTRACT

This invention relates to a system and method for securing property ownership records through a secure tamper-proof biometric verification and blockchain technology; Biometric Identity Lock Instrument (BILI). The invention Biometric Identity Lock Instrument (BILI) captures a property owner's biometric data, encrypts it, integrates biometric authentication to property deeds, links it to a blockchain-based registry, and legal frameworks. The system generates secure documents for locking and unlocking transactions, preventing unauthorized property transfers and mitigating fraud. The BILI document is generated with a unique QR code and serial number for dual physical-digital verification, ensuring transparency and security in real estate transactions. This method is particularly applicable to real estate and government-backed loan systems.

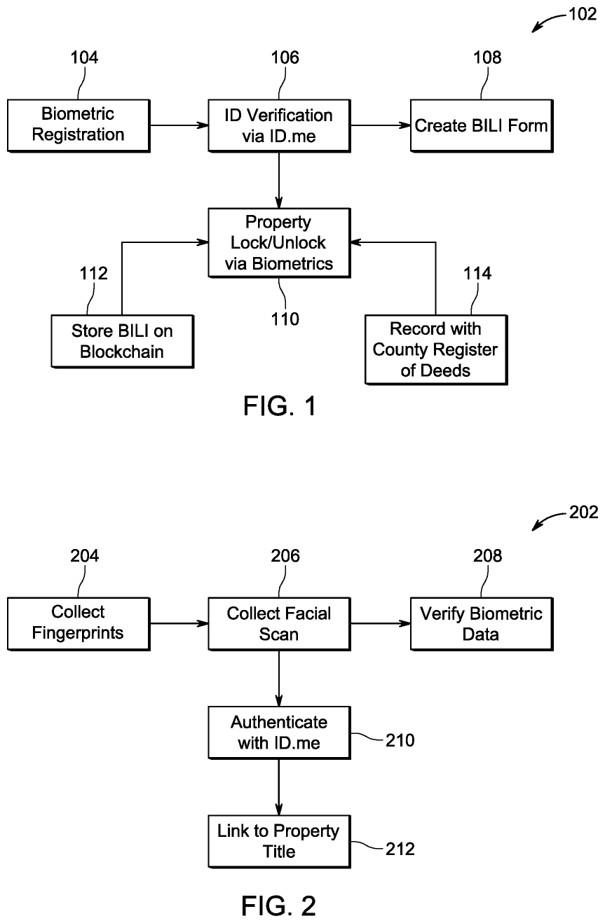

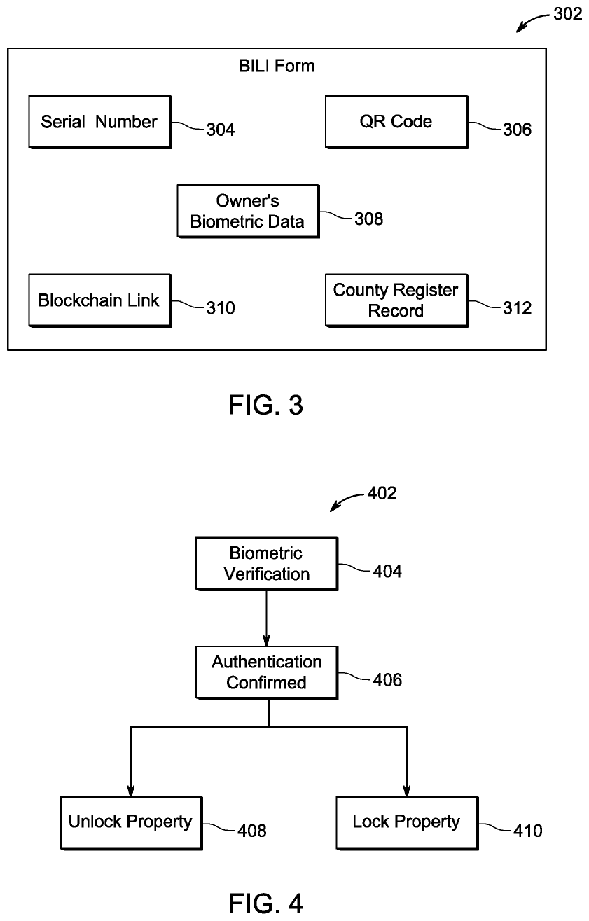

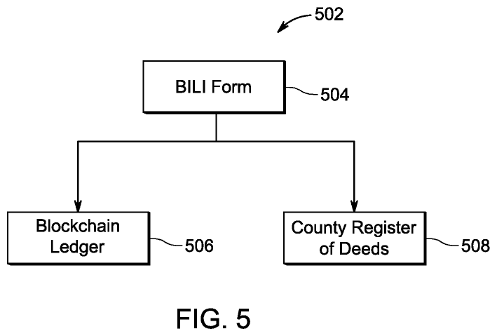

### BACKGROUND OF THE INVENTION

Property-deed fraud and unauthorized access are common issues, often enabled by the lack of secure, verifiable ownership records. Traditional methods of securing property ownership rely on physical deeds, which are susceptible to forgery and unauthorized transfers. The present invention, BILI, addresses these limitations by establishing ownership through biometric identity verification and recording ownership details on both blockchain and public county registers.

### SUMMARY OF THE INVENTION

This invention introduces a method, referred to as the Biometric Identity Lock Instrument (BILI), which uses biometric data, including fingerprints and facial scans, to authenticate property ownership. The method comprises steps for collecting biometric data, creating a document (BILI form) that links this data to property records, and storing the document on both a blockchain ledger and in the local county register of deeds. This dual storage ensures a legally recognized and tamper-proof record.

### DETAILED DESCRIPTION OF THE METHOD

### Step 1: Biometric Registration

The method begins by collecting biometric data from the property owner. This data includes multiple biometric identifiers such as fingerprints and facial scans, which are securely registered through a third-party identity verification service, such as ID.me. This step ensures the authenticity of the data and prevents unauthorized individuals from claiming ownership.

### Step 2: ID Verification via ID.me

Following biometric registration, the method involves verification of the property owner's identity using ID.me or a similar trusted third-party service. This identity verification step is essential for confirming that the individual attempting to register the property is indeed the rightful owner.

### Step 3: BILI Document Creation

Upon successful verification, the system generates a document known as the BILI form. This document records the owner's biometric data and links it to the property title, establishing a biometric-based ownership record. The BILI form contains:
Serial Number: A unique identifier for document tracking.
QR Code: A scannable code for quick access and verification of the document.
Blockchain Link: A reference to the blockchain record where the BILI form is stored.
County Register Record: A reference indicating that the BILI form is also stored in the local county register of deeds, adding a public, legally recognized record of ownership.

### Step 4: Property Lock/Unlock via Biometrics

The BILI method includes a lock/unlock functionality, controlled by the property owner's biometric data. This feature serves multiple purposes beyond physical access:
Transactional Recordings: When the property owner needs to record official updates to the property title, such as a Notice of Commencement (NOC), Home Equity Line of Credit (HELOC), refinancing, or any other document requiring registration, the property must first be ‘unlocked’ by the owner. This unlock action, verified by the owner's biometrics, authorizes the system to proceed with recording new information on the title.
Enhanced Security: By requiring biometric authentication to unlock the property for title-related transactions, the BILI method ensures that only the verified owner can initiate changes to the title.
   This adds an additional layer of security against unauthorized title modifications.

### Step 5: Blockchain Storage

The BILI form is then uploaded to a blockchain ledger, creating a time-stamped, immutable record of ownership. Blockchain technology provides a secure, transparent, and tamper-resistant environment for storage, making it impossible for unauthorized parties to alter the record.

### Step 6: County Register of Deeds Recording

Finally, the BILI form is recorded with the local county register of deeds. This public record creates an additional layer of legal recognition, ensuring that the ownership record is accessible and verifiable by public authorities.

### Example Scenario

Jane Doe, a homeowner, accesses the BILI system to secure her property against fraudulent title transfers. She verifies her identity through ID.me and submits her fingerprint and facial scan as part of the biometric registration process. Upon successful verification, the system generates a BILI form unique to her property. This document includes her biometric data, a serial number, a QR code, and links to both the blockchain ledger and the local county register of deeds. Later, Jane decides to take out a HELOC. To authorize this, she logs into BILI, provides her fingerprint or facial scan, and unlocks her property's title. This unlock action allows the BILI system to update her title to reflect the HELOC. After the transaction, the title is relocked, ensuring only authorized changes are made to her property record.

1. A system and method for securing property ownership records, and access using biometric identity verification.

1A. Capturing biometric data of a property owner through a biometric scanning device.

1B. Encrypting biometric data to generate a unique digital identifier.

1C. Linking the encrypted biometric identifier to a property deed stored in a blockchain-based registry and recording with the county register of deeds.

1D. Generating a secure tamper-proof Biometric Identity Lock Instrument (BILI) document that includes the encrypted biometric identifier, property details, a QR code linked to the blockchain record, a unique serial number for manual verification, and county registry reference; enabling a property lock/unlock function based on biometric verification.

1E. Authenticating and authorizing property transactions exclusively through biometric verification.

2. The method of claim 1, wherein the biometric data includes multiple identifiers such as fingerprints, retinal scans, and facial recognition patterns providing an enhanced security layer.

3. The method of claim 1, wherein the document is verified by a trusted third-party service such as ID.me.

4. The method of claim 1, wherein the blockchain registry employs distributed ledger technology for immutability and decentralized verification.

5. The method of claim 1, further comprises a notary verification process integrated with the BILI system and is compatible with government-backed loan systems.

6. The method of claim 1, wherein unlocking the property for title transactions requires the owner's biometric verification.

7. The method of claim 1, further encompasses an audit trial for all transactions recorded in the blockchain registry.

8. The method of claim 1, wherein the BILI document is electronically verified via QR codes or Patent Application: Biometric Identity Lock Instrument (BILI) serial numbers.

9. The method of claim 1, wherein the BILI form, is linked to both a blockchain ledger and a county register of deeds for legal and digital security.
